(19) United States
(12) Patent Application Publication
(10) Pub. No.: US 2026/0046505 A1
(43) Pub. Date: Feb. 12, 2026

(54) CAMERA ARRANGEMENT FOR MONITORING A DRIVER OF A VEHICLE, WITH AN LED DIRECTLY MOUNTED TO A PLUG ELEMENT OF A CONNECTOR DEVICE

(71) Applicant: VALEO SCHALTER UND SENSOREN GMBH, Bietigheim-Bissingen (DE)

(72) Inventor: Jan Konopisky, Prague (CZ)

(73) Assignee: VALEO SCHALTER UND SENSOREN GMBH, Bietigheim-Bissingen (DE)

(21) Appl. No.: 18/998,712

(22) PCT Filed: Jul. 12, 2023
(86) PCT No.: PCT/EP2023/069258

§ 371 Date: Jan. 27, 2025

(30) Foreign Application Priority Data
Jul. 27, 2022 (DE) 10 2022 118 822.1

(51) Int. Cl. H04N 23/56; H04N 23/51; H04N 23/54

(52) U.S. Cl. CPC H04N 23/56; H04N 23/51; H04N 23/54

(57) ABSTRACT

A camera arrangement for monitoring a driver of a vehicle, with an image capture device including a lens element providing a field of view to an image sensor of the image capture device. The image capture device is mounted to a circuit board. A light source unit is configured to illuminate an object to be captured by the image sensor. A top side of the lens element and a top side of the light source unit have substantially equal distances from the circuit board. The light source unit is electrically connected to a base plug of a connector device. The base plug is mounted to the circuit board. The light source unit is directly mounted to a further plug element of the connector device, which is electrically connected to the base plug.

The invention relates to camera arrangement for monitoring a driver of vehicle. The camera arrangement comprises an image capture device with at least one lens element for providing a field of view to an image sensor of the image capture device. The image capture device is mounted to a circuit board of the camera arrangement. The camera arrangement comprises a light source unit configured to illuminate an object to be captured by the image sensor. A top side of the at least one lens element and a top side of the light source unit have substantially equal distances from the circuit board. The light source unit is electrically connected to a base plug of a connector device of the camera arrangement. The base plug is mounted to the circuit board.

In a driver monitoring system comprising such a camera arrangement or camera package, it is a challenge to find a good position for the light source unit relative to the at least one lens element. This is due to the fact that the image capture device comprising the at least one lens element usually has a greater height than the light source unit. If the light source unit is arranged on the same circuit board as the image capture device in rather close proximity to the image capture device, a field of illumination of the light source unit can be partly obstructed by the image capture device, in particular by the at least one lens element of the image capture device.

It is therefore beneficial, if the light source unit and the at least one lens element are arranged at approximately equal heights above the circuit board. However, current approaches to this challenge are not satisfactory, because they are rather cost intensive and not effective with respect to the overall package.

For example, document CN 213693912 U describes a camera with a housing, wherein a main circuit board and a supplementary circuit board are fixedly arranged at openings on opposite sides of the housing. An infrared light source is arranged on a top side of the supplementary circuit board, and a female connector of a plug-in-assembly is arranged on a bottom side of the supplementary circuit board, which is opposite to the top side. A male connector of the plug-in-assembly is arranged on the main circuit board. By connecting the female connector to the male connector, the supplementary circuit board is electrically connected to the main circuit board.

The utilization of such a plug-in-assembly or board-to-board-connector is laborious with respect to the assembly process. This is in particular due to the fact that the male connector is hidden by the supplementary circuit board during a process in which the female connector shall be connected to the male connector. Therefore, a blind assembly must be performed. Further, the supplementary circuit board requires additional installation space. This is also disadvantageous.

Other camera arrangements, wherein a top side of a light source unit and a top side of an image capture device are arranged at substantially equal distances from a circuit board, are described in documents U.S. Pat. No. 7,679,673 B2 and US 2021/195076 A1, respectively.

It is an object of the present invention to provide a camera arrangement of the initially mentioned kind, which allows for a particularly simple assembly.

This object is solved by the camera arrangement having the features of claim 1. Advantageous configurations with convenient further developments of the invention are specified in the dependent claims and in the following description.

The camera arrangement according to the invention for monitoring a driver of a vehicle comprises an image capture device with at least one lens element providing a field of view to an image sensor of the image capture device. The image capture device is mounted to a circuit board of the camera arrangement. A light source unit of the camera arrangement is configured to illuminate an object to be captured by the image sensor. Herein, a top side of the at least one lens element and a top side of the light source unit have substantially equal distances from the circuit board. The light source unit is electrically connected to a base plug of a connector device of the camera arrangement, wherein the base plug is mounted to the circuit board. The light source unit is directly mounted to a further plug element of the connector device, wherein the further plug element is electrically connected to the base plug.

This camera arrangement allows for a particularly simple assembly. This is in particular due to the fact that the light source unit directly contacts the further plug element to which the light source unit is mounted. Consequently, no further component such as an additional circuit board or the like is arranged between the light source unit and the further plug element. As a consequence, no installation space is needed for such a further component.

Additionally, no such further component obstructs a view of a person or an assembly robot or the like when connecting the further plug element to the base plug. Therefore, a blind assembly is avoided in an assembly process, in which the further plug element is being connected to the base plug. This is advantageous.

It is additionally advantageous that a number of components to be assembled is reduced compared to a camera arrangement having two circuit boards and a board-to-board connector coupling the two circuit boards electrically with each other. The reduced number of components contributes to the simplicity of the assembly. Further, reducing the number of components to be assembled goes along with lower costs for providing the camera arrangement.

And as the top side of the at least one lens element and the top side of the light source unit each have substantially the same distance from the circuit board, the lens element and the light source unit can be arranged rather close to each other without the field of illumination of the light source unit being obstructed by the at least one lens element. Due to this advantageous geometrical arrangement of the field of view on the one hand and the field of illumination on the other hand, a particularly small package of the camera arrangement can be achieved.

In particular, the distance of the top side of the at least one lens element from the circuit board and the distance of the top side of the light source unit from the circuit board shall be considered substantially equal, if these distances do not differ from each other by more than 25 %, preferably by not more than 20 %, in particular by not more than 10 %.

Preferably, during assembly of the camera arrangement, the light source unit is directly mounted or coupled to the further plug element in a first step, and in a second step, the plug element carrying the light source unit is electrically connected to the base plug. This simplifies the assembly process.

Preferably, an extension of the light source unit in a direction, which is perpendicular to a mounting direction when connecting the further plug element to the base plug, is inferior or equal to an extension of the further plug element in the direction, which is perpendicular to the mounting direction. In other words, the light source unit does preferably not extend beyond an outer circumference of the further plug element. This is particularly advantageous for the mounting process, in which the further plug element with the light source unit on top of it is handled and accordingly moved in the mounting direction. This is in particular due to the fact that the light source unit mounted on the top of further plug element does not obstruct a view towards the base plug.

Preferably, the camera arrangement comprises a housing with a first opening for the at least one lens element and a second opening for the light source unit. Herein, the light source unit is located within the second opening. On the one hand, this facilitates the installation of the further plug element equipped with the light source unit contacting a top side of the further plug element.

On the other hand, it can thus be achieved that both the top side of the at least one lens element and the top side of the light source unit are substantially flush with a wall of the housing having the first opening and the second opening. This is particularly beneficial for arranging the at least one lens element and the light source unit within the respective opening in a well-protected manner.

Preferably, the base plug has a socket element into which a protrusion of the further plug element is inserted. Herein, the socket element has a cross slot device with a plurality of pillar elements delimiting a plurality of recesses. The protrusion has a cross head device with a plurality of wall elements engaged in the recesses between the pillar elements. Preferably, the cross head device further comprises a plurality of outer grooves into which the pillar elements are inserted. Inserting the cross head device of the protrusion into the cross slot device of the socket element provides a particularly good guidance when electrically and mechanically connecting the further plug element to the base plug. Additionally, a movement of the further plug element relative to the base plug, which may be caused by vibrations occurring during the utilization of the camera arrangement for monitoring the driver of the vehicle, can be avoided to a particularly large extent.

Still further, inserting the wall elements in the recesses that are formed between adjacent pillar elements and preferably inserting the pillar elements in the outer grooves of the cross head device goes along with a particularly tight engagement of the further plug element with the base plug. Moreover, it can readily be achieved that an outer circumference of the further plug element substantially corresponds to an outer circumference of the base plug. This is beneficial with respect to the installation space required by the connector device comprising the base plug and further plug element.

In particular, if the further plug element has a relatively large height, the pillar elements of the cross slot device and the corresponding outer grooves of the cross head device are helpful in assuring a very robust fixation of the further plug element to the base plug. This is especially valid, if a length of the pillar elements is several times a thickness of the circuit board.

The cross slot device can in particular comprise four pillar elements each arranged in respective corners or corner regions of the base plug. Correspondingly, the cross head device of the protrusion can comprise four outer grooves arranged in four corners or corner regions of the protrusion. Consequently, four wall elements are arranged between two pillar elements, respectively. Such a configuration allows for a simple production of the connector device and a very reliable and space saving mechanical connection of the further plug element to the base plug. Additionally, providing the four pillar elements at respective corners of the base plug goes along with a high stability and robustness of the base plug.

Preferably, the cross slot device comprises a central pin inserted into a central depression provided in a main body of the further plug element. Such an engagement of the central pin within the central depression contributes to a very robust connection of the further plug element to the base plug.

Preferably, at least one of the central pin and the pillar elements comprises an electrical connector which is electrically connected to a contact lug of the further plug element. By such an arrangement of the electrical connector, the electrical connection between the further plug element and the base plug can be readily established.

The central pin can comprise an electrical connector of a first polarity, wherein at least one of the pillar elements can comprise an electrical connector of a second polarity. By providing such an arrangement of the electrical connectors, an electrical connection of the further plug element to the base plug, in which a correct polarity of the contact lugs is assured, can be achieved in a very simple and fail-safe or reliable manner.

In particular, it can be achieved that irrespective of the orientation of the cross slot device with respect to the cross head device, the further plug element and therefore also the light source unit is connected in correct polarity to the base plug.

In particular, each one of the pillar elements can comprise an electrical connector of the same polarity wherein the central pin can comprise an electrical connector of the other polarity. This goes along with a very simple electrical connection of the further plug element to the base plug.

In a variant of the connector device it is possible that the further plug element has the cross slot device and that the base plug has the corresponding cross head device. However, providing the pillar elements as components of the base plug goes along with a particularly high stability of this part of the connector device and with a good fixation of the base plug to the circuit board.

Preferably, the light source has a base plate, wherein electrical contact elements of the light source unit are arranged at a narrow side of the base plate. Herein, the electrical contact elements of the light source unit are electrically connected to contact lugs of the further plug element. With the electrical contact elements of the light source unit being arranged at the narrow side of the base plate, in particular at opposite narrow sides of the base plate, these electrical contact elements are readily accessible when electrically connecting the light source unit to the further plug element.

Additionally, a person and/or an assembly robot or the like performing the installation of the light source unit on the top of the further plug element can readily verify whether the electrical contact elements arranged at the narrow side of the base plate are in good electric contact with the corresponding contact lug of the further plug element. This is also beneficial with respect to a good electrical connection of the light source unit to the further plug element.

The electrical contact elements of the light source unit can be inserted into slots provided in the further plug element. This allows for a very simple and reliable connection of the electrical contact elements to the contact lugs of the further plug element.

Alternatively or additionally, a bottom side of the base plate can be fixed to a top side of the further plug element by means of an adhesive. This allows for an easy assembly and a particularly good fixation of the light source unit to the further plug element. Further, any movement of the light source unit relative to the further plug element can be readily avoided.

This is, in particular, advantageous as during the utilization of the camera arrangement for monitoring the driver of the vehicle, the connector device and therefore also the plug element can be exposed to vibrations.

In particular, if the electrical contact elements are configured as contact leaves that are inserted into the slots provided in the further plug element, it is advantageous to fix the bottom side of the base plate to the top side of the further plug element by means of the adhesive. This is due to the fact that in such an arrangement, the contact elements are not required to provide any fixation of the light source unit to the further plug element but only to establish the electrical contact with the contact lugs of the further plug element.

Preferably, the adhesive is stable at temperatures of up to about 120° C. to 130° C., in particular at about 125° C. This is due to the fact that temperatures in this range can occur when the light source unit is operated.

Alternatively or additionally, a main body of the further plug element can have at least one latch element with a locking tab engaged behind a top side of the base plate. Such an arrangement allows for a very simple fixation of the light source unit to the further plug element by clipping the light source unit to the further plug element. Further, there is a haptic and/or acoustic feedback during assembly as the locking tab clips into place behind the top side of the base plate. This is advantageous for assuring a simple assembly.

In particular, the main body of the further plug element can have two latch elements, wherein each latch element has a locking tab engaged behind the top side of the base plate. This allows for a particularly good and simple fixation of the light source unit to the further plug element.

Alternatively or additionally, at least one of the contact lugs of the further plug element can protrude beyond an upper side of a main body of the further plug element. This is helpful for visually verifying whether a good electrical connection between the electrical contact elements of the light source unit and the contact lugs of the further plug element is established during assembly.

Alternatively or additionally, at least one of the contact lugs of the further plug element can have a clip element engaged behind a top side of the base plate. In such an arrangement, the contact lugs do not only serve for establishing the electrical contact between the further plug element and the light source unit, but they also assure the mechanical fixation of the light source unit to the further plug element. This is advantageous.

As the contact lugs of the further plug element can in particular be made from metal, the contact lugs are rather robust. It is therefore beneficial, if these robust contact lugs are at the same time utilized for the mechanical fixation of the light source unit to the further plug element.

Alternatively or additionally, at least one of the electrical contact elements of the light source unit can be electrically connected to a corresponding one of the contact lugs of the further plug element by a portion of a solder material. Soldering the electrical contact elements to the corresponding contact lugs accounts for a particularly robust and reliable fixation of the light source unit to the further plug element.

Further, a very good electrical and thermal contact between the light source unit and the further plug element can be achieved by soldering. Additionally, soldering the light source unit to the further plug element can readily eliminate any movement of the light source unit relative to the further plug element, even if the camera arrangement is exposed to vibrations which are common during the utilization of the camera arrangement in the vehicle.

Preferably, a main body of the base plug is mounted to the circuit board by electrically connecting at least one electrical connector of the base plug to a corresponding contact of the circuit board. Herein, the main body of the base plug is supported by the at least one electrical connector. In such an arrangement, the at least one electrical connector does not only establish the electrical connection of the base plug to the contact on the circuit board. Rather, the good fixation of the base plug to the circuit board can be achieved by the at least one electrical connector. This is, in particular, valid if the at least one electrical connector is connected to the corresponding contact of the circuit board by soldering.

Preferably, the at least one lens element and the light source unit are arranged behind a protective cover element of the camera arrangement. Herein, the protective cover element is translucent for the light that can be emitted by the light source unit. The protective cover element efficiently prevents dust or dirt to impair the at least one lens element and the light source unit. This is advantageous.

The light source unit can in particular be a light emitting diode (LED) or light emitting diode element, wherein the light emitting diode element or LED element is configured to emit infrared light. By utilizing infrared light to illuminate the driver a very discrete monitoring of the driver of the vehicle can be achieved when the camera arrangement is operated.

The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim.

Moreover, implementations and feature combinations are to be considered as disclosed, in particular by the implementations set out above, which extend beyond or deviate from the feature combinations set out in the relations of the claims.

Further features of the invention are apparent from the claims, the figures and the description of figures. There show:

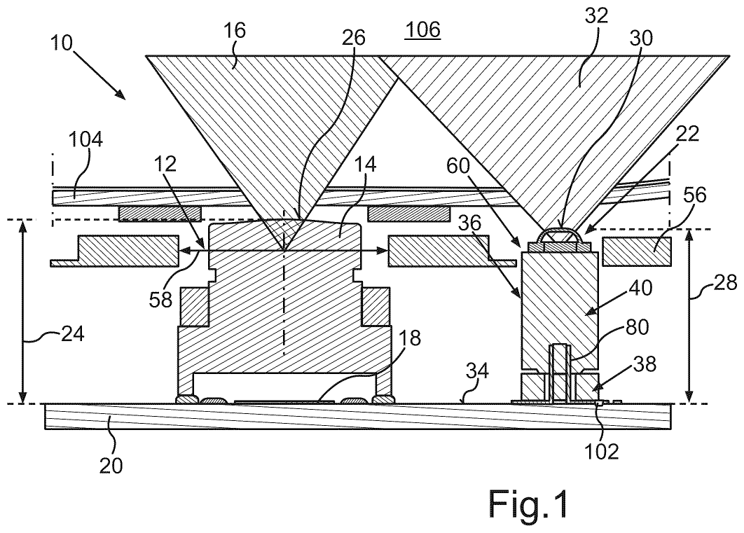

FIG. 1 a schematic section view of a camera arrangement comprising an image capture device and a light source unit arranged adjacent to the image capture device, wherein the light source unit is electrically connected to a circuit board by means of a connector device comprising a base plug mounted to the circuit board and a further plug element electrically connected to the base plug;

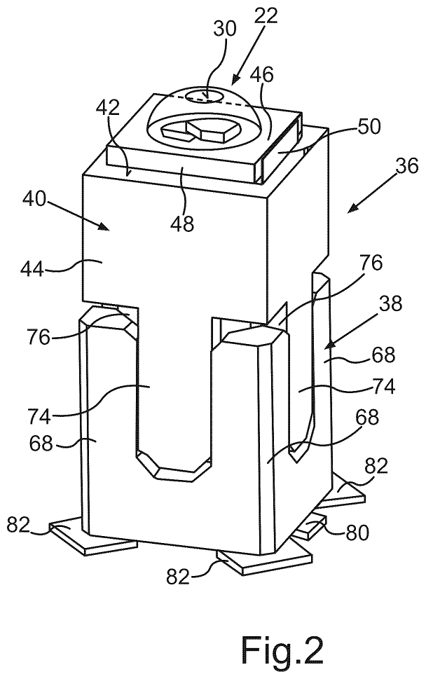

FIG. 2 a perspective view of the connector device with the light source unit directly mounted to a top side of the further plug element;

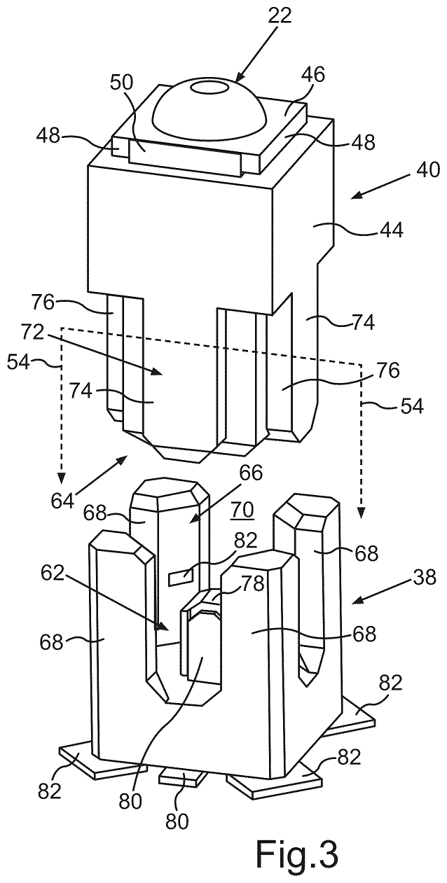

FIG. 3 a step during the assembly process of the camera arrangement, wherein the further plug element is coupled to the base plug;

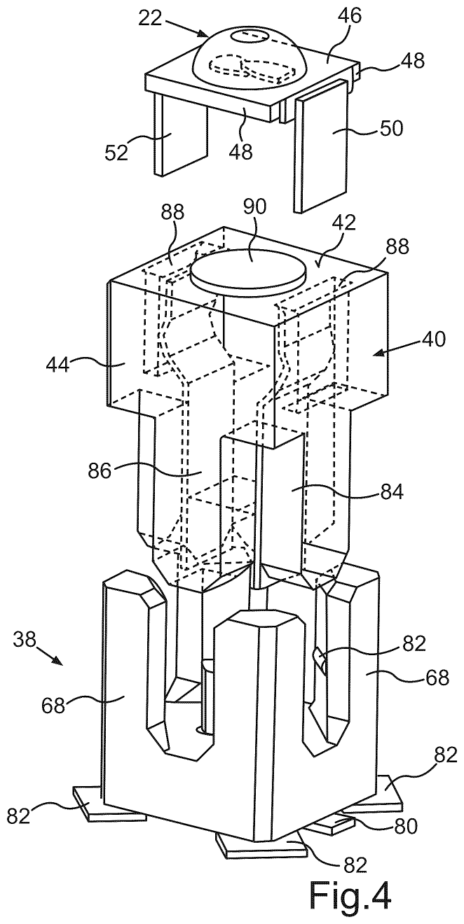

FIG. 4 an exploded view of the connector device and the light source unit according to a first variant in which electrical contact elements of the light source unit are inserted into slots provided in the further plug element;

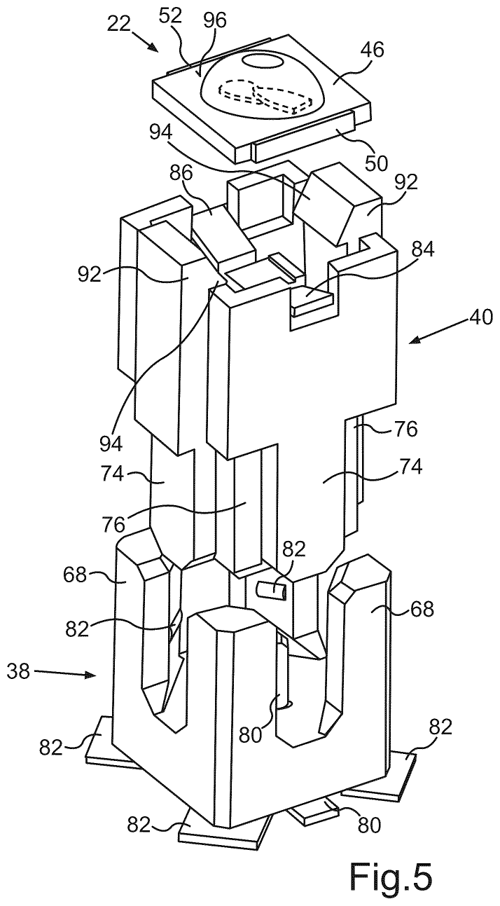

FIG. 5 an exploded view of the connector device and the light source unit according to a further variant, wherein the light source unit is mechanically fixed to a main body of the further plug element by latch elements made in one piece with the main body;

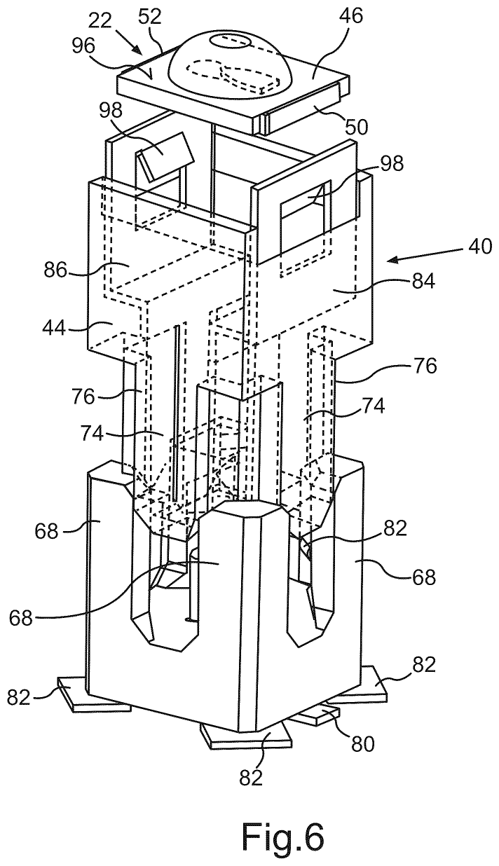

FIG. 6 an exploded view of a further variant of the connector device and the light source unit, wherein the light source unit is held by clip elements provided by electrical contact lugs of the further plug element; and

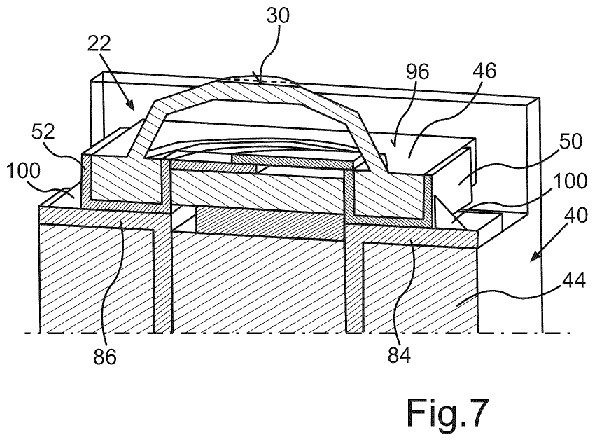

FIG. 7 a schematic section view of the light source unit coupled to the further plug element, wherein the electrical connection between the electrical contact elements of the light source unit and contact lugs of the further plug element is established by soldering.

In the figures, identical or functionally identical elements are provided with identical reference signs.

FIG. 1 shows a schematic sectional view of components of a camera arrangement 10 which can, in particular, be configured to monitor a driver of a vehicle. The camera arrangement 10 comprises an image capture device 12. The image capture device 12 comprises at least one lens element 14 providing a field of view 16 to an image sensor 18 of the image capture device 12. The image capture device 12 is mounted to a circuit board 20 of the camera arrangement 10.

Adjacent to the image capture device 12, a light source unit which can, in particular, be configured as a light emitting diode element or LED element 22 is arranged. The LED element 22 can in particular be configured to emit infrared light for illuminating the driver of the vehicle that is to be monitored by means of the camera arrangement 10 having the image capture device 12.

As can be seen from FIG. 1, a distance 24 between a top side 26 of the lens element 14 and the circuit board 20 is substantially equal to a distance 28 between a top side 30 of the LED element 22 and the circuit board 20. In other words, the top side 26 of the lens element 14 and the top side 30 of the LED element 22 are arranged at approximately the same height above the circuit board 20, respectively. This is beneficial for not obstructing a field of illumination 32 of the LED element 22 by the lens element 14.

The at least one lens element 14 can in particular comprise a plurality of individual lenses. However, in the schematic representation of FIG. 1, only one lens element 14 is shown for reasons of simplicity. If the image capture device 12 comprises a plurality of lenses, the top side of the uppermost or outermost lens of such a lens arrangement is to be considered as the top side 26 of the at least one lens element 14.

Usually the at least one lens element 14 or such a lens arrangement is much higher than the LED element 22. Therefore, an obstruction of the field of illumination 32 of the LED element 22 would occur, if the LED element 22 was mounted directly to the circuit board 20 in close proximity to the image capture device 12. As can be seen from FIG. 1, the LED element 22 is therefore raised with respect to an upper surface 34 of the circuit board 20 by means of a connector device 36.

By providing the connector device 36, it is achieved that the distance 28 from the top side 30 of the LED element 22 to the upper surface 34 of the circuit board 20 is substantially equal to the distance 24 from the top side 26 of the lens element 14 to the upper surface 34 of the circuit board 20.

The connector device 36 comprises a base plug 38 mounted to the circuit board 20, in particular according to a surface mounted technology. The base plug 38 can therefore also be referred to as an example of a surface mounted device (SMD). The connector device 36 also comprises a further plug element 40 which is mechanically coupled to the base plug 38 and which is also electrically connected to the base plug 38. By means of the further plug element 40, the LED element 22 is electrically connected to the base plug 38 and thus also to the circuit board 20.

By arranging the LED element 22 such that the top side 30 of the LED element 22 and the top side 26 of the lens element 14 have substantially the same distances 24, 28 from the circuit board 20, the LED element 22 can be arranged in rather close proximity to the image capture device 12, wherein the field of view 16 and the field of illumination 32 preferably originate at substantially equal heights above the circuit board 20.

FIG. 2 shows the connector device 36 comprising the LED element 22 directly mounted to the further plug element 40. In particular, a lower side of the light source unit configured as the LED element 22 can be in contact with a top side 42 of a main body 44 of the further plug element 40. The main body 44 can in particular made from plastic.

According to FIG. 2 the LED element 22 preferably comprises a base plate 46 which can in particular be rectangular as shown in FIG. 2. The base plate 46 has a plurality of narrow sides 48, wherein only some of the narrow sides 48 are provided with reference signs in the figures for reasons of simplicity.

As can be further seen from FIG. 2 in particular in combination with FIG. 7, electrical contact elements 50, 52 of the LED element 22 are arranged at the narrow sides 48 of the base plate 46. In particular, a first electrical contact element 50 having a first polarity can be arranged on a first narrow side 48 of the base plate 46, wherein a second electrical contact element 52 (see FIG. 7) having another polarity can be arranged on an opposite narrow side 48 of the base plate 46.

It can be further seen from FIG. 2, for example, that an extension of the LED element 22 in a direction which is perpendicular to a mounting direction 54 when connecting the further plug element 40 to the base plug 38 (see FIG. 3) is inferior to an extension of the further plug element 40 in the direction which is perpendicular to the mounting direction 54. The mounting direction 54 is indicated by a pair of arrows in FIG. 3.

In other words, the LED element 22 does preferably not extend beyond an outer circumference of the further plug element 40 perpendicularly to the mounting direction 54. This simplifies the assembly of the further plug element 40 having the LED element 22 on top of it, when the further plug element 40 is mechanically and electrically connected to the base plug 38.

As can be seen from FIG. 1, the camera arrangement 10 preferably comprises a housing with a first opening 58 for the lens element 14 and with a second opening 60 for the LED element 22. Herein, the LED element 22 is located within the second opening 60. Therefore, when the further plug element 40 is connected to the base plug 38 by inserting the further plug element 40 through the second opening 60, the base plug 38 is well visible through the second opening 60.

The mechanical connection of the further plug element 40 to the base plug 38 mounted to and electrically connected to the circuit board 20 can in particular be illustrated with reference to FIG. 3.

Accordingly, the base plug 38 has socket element 62 into which a protrusion 64 of the further plug element 40 is inserted. The socket element 62 has a cross slot device 66 with a plurality of pillars or pillar elements 68 delimiting a plurality of recesses 70. In the exemplary variant shown in FIG. 3, there are four pillar elements 68 and consequently four recesses 70 delimited by a respective pair of pillar elements 68. For reasons of simplicity, only one of the recesses 70 is provided with a reference sign in FIG. 3.

The protrusion 64 has a cross head device 72 with a plurality of wall elements 74. In FIG. 3, only two of the four wall elements 74 are visible, and only these wall elements 74 are provided with a reference sign. When the protrusion 64 is being inserted into the socket element 62, the wall elements 74 are being arranged in the corresponding one of the recesses 70 of the cross slot device 66.

Further, the cross head device 72 preferably has a plurality of outer grooves 76 arranged in the four corner regions of the cross head device 72. When the protrusion 64 is inserted into the socket element 62, the pillar elements 68 are inserted into a corresponding one of the outer grooves 76. This arrangement or engagement of the pillar elements 68 in the corresponding outer grooves 76 can be well seen in FIG. 2.

According to FIG. 3, the cross slot device 72 preferably comprises a central pin 78 which is inserted into a central depression (not visible in FIG. 3) provided in the main body 44 of the further plug element 40.

As can be further seen from FIG. 3 in particular in combination with FIG. 2, the central pin 78 preferably comprises a first electrical connector 80 having a first polarity. Additionally, the pillar elements 68 preferably comprise second electrical connectors 82 which have a second polarity.

A portion of one of these second electrical connectors 82, which is arranged on an inwardly facing side of one of the pillar elements 68, can be seen in FIG. 3. Other portions of the electrical connectors 80, 82 are configured as support sections of the base plug 38, by means of which the base plug 38 can be fixed and electrically connected to the circuit board 20 (see FIG. 1).

The electrical connectors 80, 82 are electrically connected to a first contact lug 84 and a second contact lug 86, respectively, of the further plug element 40. These contact lugs 84, 86 can be arranged within the main body 44 of the further plug element 40 and are therefore not visible in FIG. 3. However, the contact lugs 84, 86 are exemplarily and schematically shown in FIG. 4, FIG. 6 and FIG. 7. By establishing an electrical contact between the contact lugs 84, 86 and the corresponding electrical connector 80, 82, the further plug element 40 is electrically connected to the base plug 38.

According to FIG. 4, the electrical contact elements 50, 52 arranged on the narrow sides 48 of the base plate 46 can be configured as contact leaves that are inserted into slots 88 provided in the further plug element 40, in particular in the main body 44 of the further plug element 40. Through these slots 88, the contact lugs 84, 86 of the further plug element 40 are accessible. The electrical contact elements 50, 52 of the LED element 22 can be brought into electrical contact with the corresponding contact lug 84, 86 of the further plug element 40 by establishing a press-fit connection. To this end, the contact lugs 84, 86 can have portions configured as spring elements which are slightly deformed when the leaf-like electrical contact elements 50, 52 are inserted into the slots 88.

As can be further seen from FIG. 4, a bottom side of the base plate 46 can be fixed to the top side 42 of the main body 44 by means of an adhesive 90, which is schematically shown in FIG. 4. Therefore, the LED element 22 or LED-unit can be fixed to the further plug element 40 by means of the adhesive 90 or glue and by establishing a press-fit connection between the electrical contact elements 50, 52 and the contact lugs 84, 86. By providing the adhesive 90, additional fixation is assured and a movement of the LED element 22 relative to the further plug element 40, for example due to vibrations, can be avoided.

In the variant shown in FIG. 5, the LED element 22 is fixed to the further plug element 40 by a pair of latch elements 92. The latch elements 92 can, in particular, be made from plastic in one piece with the main body 44 of the further plug element 40.

The latch elements 92 each have a locking tab 94 or locking nose which engages behind a top side 96 of the base plate 46, when the LED element 22 is clipped onto the further plug element 40. When the locking tabs 94 or locking noses of the latch elements 92 engage behind the top side 96 of the base plate 46, the electrical contact elements 50, 52 are automatically electrically connected to the corresponding contact lugs 84, 86 of the further plug element 40. Such a mounting step of clipping the LED element 22 to the further plug element 40 advantageously provides a haptic and acoustic feedback to, for example, a person performing the assembly.

In the variant shown in FIG. 6, the contact lugs 84, 86 protrude beyond an upper side of the main body 44 of the further plug element 40. The contact lugs 84, 86 each have a clip element 98. These clip elements 98 are engaged behind the top side 96 of the base plate 46, when the LED element 22 is mounted to the further plug element 40. In this case, the parts that establish the electrical contact between the LED element 22 and the further plug element 40, i.e. the contact lugs 84, 86, provide at the same time the mechanical fixation of the LED element 22 to the further plug element 40 and the electrical connection of the LED element 22 to the further plug element 40.

Here again, clipping the LED element 22 to the further plug element 40 provides a haptic and acoustic feedback to, for example, the person performing this assembly step. In the variant shown in FIG. 6, the latch elements 92 according to FIG. 5 do not need to be provided. However, it is possible to provide at the same time the latch elements 92 shown in FIG. 5 as well as the clip elements 98 shown in FIG. 6.

In a like manner, the fixation explained with reference to FIG. 4 can also be combined with the types of fixations explained with reference to FIG. 5 and FIG. 6. This is also valid for the variant exemplarily shown in FIG. 7. In this sectional view of a part of the further plug element 40 and the LED element 22, the electrical contact elements 50, 52 are electrically connected to the contact lugs 84, 86 by respective portions 100 of a solder material. This provides a very robust fixation of the LED element 22 to the further plug element 40.

Additionally, a good thermal and electrical contact between the electrical contact elements 50, 52 and the corresponding contact lugs 84, 86 is established.

In a like manner, the electrical connectors 80, 82 (see FIG. 2 for example) can be electrically connected by soldering to corresponding contacts 102 of the circuit board 20 (see FIG. 1), wherein only one corresponding contact 102 is provided with a reference sign in FIG. 1 for reasons of simplicity.

As can be seen from FIG. 1 and from FIG. 2, the base plug 38 can be supported by the electrical connector elements or electrical connectors 80, 82 which can be mounted to the circuit board 20, in particular by soldering. Soldering allows for a very robust fixation of the base plug 38 to the circuit board 20. According to FIG. 2 and FIG. 3 in view of FIG. 1 a base portion of each one of the pillar elements 68 can be mechanically connected to the circuit board 20 by means of a respective electrical connector 82, and the central pin 78 can be mechanically connected to the circuit board 20 by means of the electrical connector 80. This leads to a very robust fixation of the base plug 38 to the circuit board 20.

Turning again to FIG. 1, the camera arrangement 10 preferably comprises a protective cover element 104, wherein the lens element 14 and the LED element 22 are arranged behind the protective cover element 104 with respect to surroundings 106 of the camera arrangement 10. The protective cover element 104 is translucent for the light emitted by the LED element 22. Further, the protective cover element 104 prevents dust and/or dirt or the like to reach the components of the camera arrangement 10 arranged below the cover element 104 from the surroundings 106 of the camera arrangement 10.

1. A camera arrangement for monitoring a driver of a vehicle, with an image capture device comprising at least one lens element providing a field of view to an image sensor of the image capture device,
wherein the image capture device is mounted to a circuit board of the camera arrangement, and with a light source unit configured to illuminate an object to be captured by the image sensor,
wherein a top side of the at least one lens element and a top side of the light source unit have substantially equal distances from the circuit board,
wherein the light source unit is electrically connected to a base plug of a connector device of the camera arrangement, and
wherein the base plug is mounted to the circuit board,
wherein the light source unit is directly mounted to a further plug element of the connector device, wherein the further plug element is electrically connected to the base plug.

2. The camera arrangement according to claim 1, an extension of the light source unit in a direction, which is perpendicular to a mounting direction when connecting the further plug element to the base plug, is inferior or equal to an extension of the further plug element in the direction, which is perpendicular to the mounting direction.

3. The camera arrangement according to claim 1,
wherein the camera arrangement comprises a housing with a first opening for the at least one lens element and a second opening for the light source unit,
wherein the light source unit is located within the second opening.

4. The camera arrangement according to claim 1,
wherein the base plug has a socket element into which a protrusion of the further plug element is inserted,
wherein the socket element has a cross slot device with a plurality of pillar elements delimiting a plurality of recesses,
wherein the protrusion has a cross head device with a plurality of wall elements engaged in the recesses between the pillar elements and with a plurality of outer grooves into which the pillar elements are inserted.

5. The camera arrangement according to claim 4,
wherein the cross slot device comprises a central pin inserted into a central depression provided in a main body of the further plug element,
wherein at least one of the central pin and the pillar elements comprises an electrical connector which is electrically connected to a contact lug of the further plug element.

6. The camera arrangement according to claim 1,
wherein the light source unit has a base plate,
wherein electrical contact elements of the light source unit are arranged at a narrow side of the base plate, and
wherein the electrical contact elements of the light source unit are electrically connected to contact lugs of the further plug element.

7. The camera arrangement according to claim 6, wherein the electrical contact elements of the light source unit are inserted into slots provided in the further plug element and/or a bottom side of the base plate is fixed to a top side of the further plug element by an adhesive.

8. The camera arrangement according to claim 6, wherein a main body of the further plug element has at least one latch element with a locking tab engaged behind a top side of the base plate.

9. The camera arrangement according to claim 6, wherein at least one of the contact lugs of the further plug element protrudes beyond an upper side of a main body of the further plug element and/or at least one of the contact lugs of the further plug element has a clip element engaged behind a top side of the base plate.

10. The camera arrangement according to claim 6, wherein at least one of the electrical contact elements of the light source unit is electrically connected to a corresponding one of the contact lugs of the further plug element by a portion of a solder material.

11. The camera arrangement according to claim 1,
wherein a main body of the base plug is mounted to the circuit board by electrically connecting, at least one electrical connector of the base plug to a corresponding contact of the circuit board,
wherein the main body of the base plug is supported by the at least one electrical connector.

12. The camera arrangement according to claim 1,
wherein the at least one lens element and the light source unit are arranged behind a protective cover element of the camera arrangement,
wherein the protective cover element is translucent for the light that can be emitted by the light source unit.
